(19) United States
(12) Patent Application Publication
(10) Pub. No.: US 2007/0223395 A1
(43) Pub. Date: Sep. 27, 2007

(54) Methods and apparatus for optimizing a TCP session for a wireless network

(75) Inventors: Albert Lee, Aliso Viejo, CA (US); Mahadevan Kulathu Iyer, Thane (IN)

Correspondence Address: Albert Lee, 51 Sprucewood, Aliso Viejo, CA, 92656, US

(73) Assignee: IST International, Inc.

(21) Appl. No.: 11/804,876

(22) Filed: May 21, 2007

(30) Foreign Application Priority Data
Nov. 23, 2005 (US) PCT/US05/42818

(51) Int. Cl. H04J 1/16; H04J 3/22; H04L 12/56

(52) U.S. Cl. 370/252; 370/465; 370/389

(57) ABSTRACT

A plurality of network characteristics of a wireless network are determined and a plurality of TCP session parameters are updated. The network characteristics may be determined based at least in part on a comparison of the estimated bandwidth and estimated propagation delay of the wireless network and the typical bandwidths and propagation delays of one or more wireless networks. The TCP session parameters may be updated based at least in part on the network characteristics. The TCP session parameters may be used to limit the congestion window, retransmission timeout and slow start threshold.

### CROSS-REFERENCE TO RELATED APPLICATIONS

This application claims the benefit of U.S. Provisional Patent Application Ser. No. 60/630,893, filed Nov. 24, 2004, the disclosure of which is herein incorporated by reference.

### FIELD OF THE INVENTION

The invention relates, in general, to reliable end-to-end communications and, more particularly, to optimizing a Transmission Control Protocol (TCP) session for a wireless network.

### BACKGROUND OF THE INVENTION

Packet-switched data networks are commonly represented as multi-layer protocol stacks. Examples include the 7 layer Open System Interface (OSI) model and the 4 layer Transmission Control Protocol/Internet Protocol (TCP/IP) model. The ordering of the layers in the OSI model from highest to lowest is: (1) the application layer, (2) the presentation layer, (3) the session layer (4) the transport layer, (5) the network layer, (6) the data-link layer, and (7) the physical layer. The ordering of the layers in the TCP/IP model from highest to lowest is: (1) the application layer, (2) the transport layer (usually TCP), (3) the internet layer (usually IP), and (4) the network access layer. While this is the most common model, not all TCP/IP implementations follow this model. Also, while the TCP/IP model does not follow the OSI model, the TCP/IP transport layer may be mapped to the OSI transport layer and the TCP/IP internet layer may be mapped to the OSI network layer. Therefore, the data-link and physical layers in the OSI model may be considered lower layers than the transport and internet layers in the TCP/IP model. A brief discussion of the transport, network, data-link, and physical layers follows.

The transport layer is responsible for fragmenting the data to be transmitted into appropriately sized segments for transmission over the network. TCP is a transport layer protocol. The transport layer may provide reliability and congestion control processes that may be missing from the network layer. The network layer is responsible for routing data packets over the network. IP is a network layer protocol. The data-link layer manages the interfaces and device drivers required to interface with the physical elements of the network. Examples of the data-link layer include the Ethernet protocol and the Radio Link Protocol (RLP). The physical layer is composed of the physical portions of the network. Examples include serial and parallel cables, Ethernet and Token Ring cabling, antennae, and connectors.

In a TCP/IP network, applications programs that need to send data to other computers pass data to the transport layer. At the transport layer, the data is fragmented into appropriately sized segments. These segments are then passed to the network layer where they are packaged into datagrams containing header information necessary to transmit the segments across the network. The network layer then calls upon the lower level protocols (e.g. Ethernet or RLP) to manage the transmission of the data across a particular physical medium. As the datagrams are transmitted from one network to another, they may be fragmented further. At the receiving computer, the process is reversed. The lower level protocols receive the datagrams and pass them to the network layer. The network layer reassembles the datagrams into segments and passes the segments to the transport layer. The transport layer reassembles the segments and passes the data to the application.

IP is limited to providing enough functionality to deliver a datagram from a source to a destination and does not provide a reliable end-to-end connection or flow control. There is no guarantee that a segment passed to a network layer using IP will ever get to its final destination. Segments may be received out of order at the receiver or packets may be dropped due to network or receiver congestion. This unreliability was purposefully built into IP to make it a simple, yet flexible protocol.

TCP uses IP as its basic delivery service. TCP provides the reliability and flow control that is missing from IP. TCP/IP Standard 7 states that “very few assumptions are made as to the reliability of the communication protocols below the TCP layer” and that TCP “assumes it can obtain a simple, potentially unreliable datagram service from the lower level protocols” such as IP. To provide the reliability that is missing from IP, TCP uses the following tools: (1) sequence numbers to monitor the individual bytes of data and reassemble them in order, (2) acknowledgment (ACK) flags to tell if some bytes have been lost in transit, and (3) checksums to validate the contents of the segment (NOTE: IP uses checksums only to validate the contents of the datagram header).

In addition, TCP provides flow control due to the fact that different computers and networks have different capacities, such as processor speed, memory and bandwidth. For example, a web enabled mobile phone will not be able to receive data at the same speed at which a web server may be able to provide it. Therefore, TCP must ensure that the web server provides the data at a rate that is acceptable to the mobile phone. The goal of TCP's flow control system is to prevent data loss due to too high a transfer rate, while at the same time preventing under-utilization of the network resources.

Originally, most TCP flow control mechanisms were focused on the receiving end of the connection, as that was assumed to be the source of any congestion. One example of a receiver-based flow control mechanism is receive window (RWND) sizing. The size of RWND is advertised by a receiver in the ACKs that it transmits to the sender. The size of RWND is based on factors such as the size of the receiver's receive buffers and the frequency at which they are drained.

However, flow control mechanisms based on the receiver do not address problems that may occur with the network. Such problems may be network outages, high traffic loads and overflowing buffers on network routers. A receiver may be operating smoothly, but the network may be dropping packets because the sender is transmitting data at too high a rate for the network to handle. Therefore, sender-based flow control methods were developed. RFC 2581 details TCP's four flow control methods: (1) slow start, (2) congestion avoidance, (3) fast retransmit, and (4) fast recovery.

The four flow control methods are used to recover from, or to prevent, congestion related problems. Which method is used depends on which congestion related problem is encountered or to be prevented Slow start is used at the start of a connection to probe the network capacity or after a retransmission timer indicates that a segment has been lost. When a segment is transmitted or an ACK is received, the TCP sender predicts the round trip time of the next segment and calculates the retransmission timeout. When the next segment is transmitted, the retransmission timer for that segment is started with the new value of the retransmission timeout. If the retransmission timer expires before the ACK for that segment is received, then the segment is presumed lost. Congestion avoidance is used after slow-start reaches a predetermined threshold or after potential congestion is detected by the receipt of a duplicate ACK. Fast retransmit is used to retransmit a potentially lost packet before the retransmission timer indicates that it is lost. Fast recovery is used to prevent unnecessary retransmission of data.

Despite the improvements afforded by the aforementioned flow control methods, the emphasis has been on reliability of the TCP connections at the expense of network performance. Thus, there is a need in the art to optimize TCP connectivity such that neither reliability nor performance are compromised.

### BRIEF SUMMARY OF THE INVENTION

A method and apparatus for optimizing a Transmission Control Protocol (TCP) session are disclosed. In one embodiment, the method includes determining a plurality of network characteristics of the wireless network, and updating one or more TCP session parameters based on the plurality of network characteristics.

Other aspects, features, and techniques of the invention will be apparent to one skilled in the relevant art in view of the following detailed description of the invention.

### BRIEF DESCRIPTION OF THE DRAWINGS

FIG. 1 depicts a simplified system diagram of a system wherein one or more aspects of the invention may be performed, according to one or more embodiments;

FIGS. 2A-2B are graphical representations of the relative bandwidths and propagation delays of one or more wireless network types;

FIG. 3 is one embodiment of a flow diagram of how a TCP module may update TCP session parameters during a TCP session;

FIG. 4 is one embodiment of a flow diagram of how one or more TCP session parameters may be updated before, or upon, the start of a TCP session.

FIG. 5 is one embodiment of a flow diagram of how a TCP module may limit a congestion window;

FIG. 6 is a flow diagram of how a TCP module may determine a congestion window, according to one or more embodiments;

FIG. 7 is a flow diagram of how a TCP module may limit a slow start threshold, according to one or more embodiments;

FIG. 8 is a flow diagram of a TCP module may limit a retransmission timeout to less than or equal to a maximum retransmission timeout, according to one or more embodiments;

FIG. 9 is a flow diagram of a modified TCP congestion avoidance process, according to one or more embodiments; and

FIG. 10 is a flow diagram of how a TCP module may override one or more congestion window update processes, according to one or more embodiments.

### DETAILED DESCRIPTION OF EXEMPLARY EMBODIMENTS

A method and apparatus for optimizing a Transmission Control Protocol (TCP) session for a network node in communication with a wireless network are disclosed. One aspect of the invention is to determined the network characteristics of a wireless network. In one embodiment, the network characteristics may be determined by comparing an estimated bandwidth and estimated propagation delay of the wireless network to one or more sets of pre-stored network characteristics.

Another aspect of the invention is to provide a flexible method for updating one or more TCP session parameters based at least in part on the network characteristics. In one embodiment, one or more TCP session parameters may be updated with one or more corresponding pre-stored session parameters associated with the network characteristics.

Still another aspect of the invention is to limit a congestion window and slow start threshold to a range defined by a minimum congestion window and a maximum congestion window. In certain embodiments, a retransmission timeout may also be limited to less than or equal to a maximum retransmission timeout.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits. The terms “network node”, “sender”, and “receiver” are understood to include any electronic device that contains a processor, such as a central processing unit.

When implemented in software, the elements of the invention are essentially the code segments to perform the necessary tasks. The code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

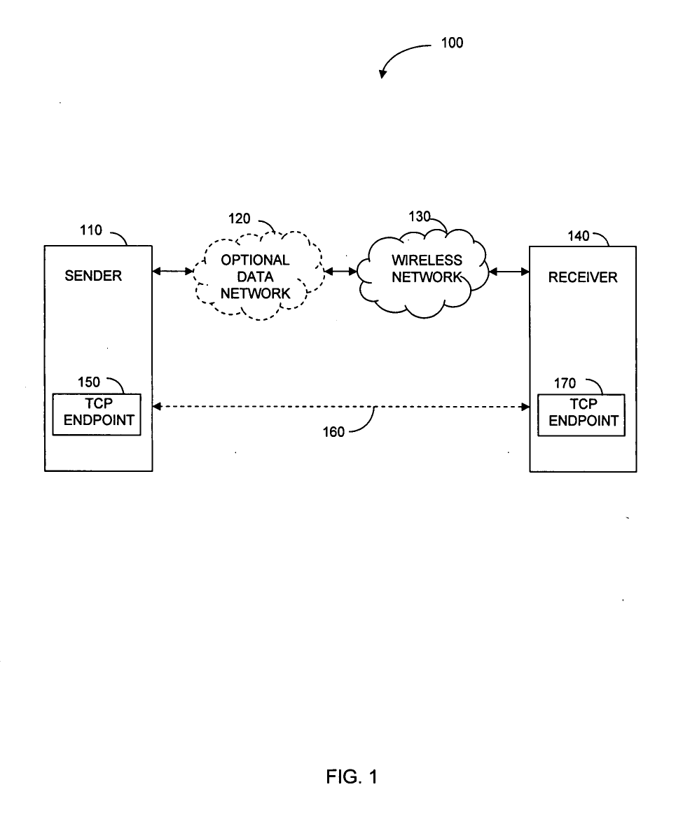

FIG. 1 depicts an exemplary system 100 in which one or more aspects of the invention may be implemented. The system 100 consists of a sender 110 in communication with a receiver 140 over an optional data network 120 and a wireless network 130. While in the embodiment shown in FIG. 1, optional data network 120 is present, in another embodiment it may be omitted.

Sender 110 may be a network node adapted to create a TCP virtual circuit 160 with another device through the use of a TCP module resident on sender 110. For example, a sender 110 may be a desktop computer, a laptop computer, a cellular telephone, a Personal Digital Assistant (PDA), a server, a network adapter, or an embedded computer. It should be appreciated that the above list is exemplary only, as any device capable of creating a TCP virtual circuit 160 with another device may be considered a sender 110. A TCP module may be part of a Transmission Control Protocol/Internet Protocol (TCP/IP) stack shared by more than one program on sender 110 or it may exist as part of another program. In addition, it should be appreciated that a sender 110 that contains a TCP module consistent with the principles of the invention may further contain other TCP modules that are not so configured.

Receiver 140 may be a network node adapted to create a TCP virtual circuit 160 with another device through the use of a TCP module resident on receiver 140. For example, a receiver 140 may be a desktop computer, a laptop computer, a cellular telephone, a Personal Digital Assistant (PDA), a server, a network adapter, or an embedded computer. It should be appreciated that the above list is exemplary only, as any device capable of creating a TCP virtual circuit 160 with another device may be considered a receiver 140. A TCP module may be part of a TCP/IP protocol stack shared by more than one software program on receiver 140 or it may exist as part of another software program. In addition, it should be appreciated that a receiver 140 that contains a TCP module consistent with the principles of the invention may further contain other TCP modules that are not configured as such.

While units 110 and 140 in FIG. 1 have been described as “sender” and “receiver” respectively, it should be appreciated that these terms are arbitrary and that sender 110 may at times be transmitting data to receiver 140, while at other times, receiver 140 may be transmitting data to sender 110.

In the embodiment of FIG. 1, a TCP virtual circuit 160 exists between sender TCP endpoint 150 and receiver TCP endpoint 170. While the details of a TCP virtual circuit are beyond the scope of the present disclosure, they are shown in FIG. 1 to illustrate that reliable TCP sessions, with their attendant flow control algorithms, may be created in sender 110 and receiver 140, even if the underlying network protocols and networks are unreliable. It should be understood that more than one TCP virtual circuit 160 between sender 110 and receiver 140 may exist simultaneously.

Optional data network 120 may consist of a single network or multiple interconnected networks. Examples of networks that may make up optional data network 120 include the Internet, local area networks, wide area networks, digital subscriber line (DSL) networks, cable networks, dial-up networks, cellular data networks, and satellite networks. They may be packet-switched networks or circuit-switched networks. The above list of networks that may make up optional data network 120 is exemplary only and it should be appreciated that any network that may be connected to another network through the use of one or more network layer protocols, such as the Internet Protocol (IP), may be used.

Wireless network 130 may consist of a single network with at least one wireless physical link, or multiple interconnected networks wherein at least one network contains at least one wireless physical link. Wireless network 130 may be a cellular data network, such as a Code Division Multiple Access 2000 1× (CDMA2000 1×) network, a Code Division Multiple Access 2000 1× Evolution Data Only (CDMA2000 1×EVDO) network, a General Packet Radio Services (GPRS) network, a Universal Mobile Telecommunications System (UMTS) network, a Universal Terrestrial Radio Access Network (UTRAN) network, and an Enhanced Data for GSM Evolution (EDGE) network. The above list of networks that may make up wireless network 130 is exemplary only and it should be appreciated that any wireless network that may be connected to another network through the use of one or more network layer protocols, such as IP, may be used.

Different wireless network types generally have different network characteristics, such as bandwidths and propagation delays. As such, wireless network types may be differentiated from one another by these network characteristics. For example, a CDMA2000 1× network will generally have a lower bandwidth and a higher propagation delay than a CDMA2000 1×EVDO network. The network characteristics may include a minimum bandwidth (B1), a maximum bandwidth (B2), a minimum propagation delay (D1), a maximum propagation delay (D2), a minimum network buffer capacity (min_net_buffer), and a maximum network buffer capacity (max_net_buffer). It should be appreciated that the above list is not exhaustive and other network characteristics may be included.

It should be appreciated that the propagation delay of a wireless network type may also be termed the latency of a wireless network type, as the term is known in the art.

The values of B1, B2, D1, and D2 for a wireless network type may be set by several methods. One method may be to run tests under varying loads over a wireless network and record the observed values for the bandwidth and propagation delay. B1 and B2 may be set to the minimum and maximum observed bandwidths, respectively. D1 and D2 may be set to the minimum and maximum observed propagation delays, respectively. It should be appreciated that in certain embodiments, values other than the minimum and maximum bandwidths and propagation delays may be used to set B1, B2, D1, and D2, such as the observed average minimum and maximum bandwidths and propagation delays. Another method may be to calculate B1, B2, D1, and D2 using one or more specifications of the wireless network type. It should be appreciated that a combination of the two methods may be also used. The above methods are listed for illustrative purposes only and the method, or methods, used to set B1, D2, D1, and D2 are not critical and different methods may yield different results.

The values for min_net_buffer and max_net_buffer may be set by several methods. One method may be to run tests under varying loads over a wireless network. Another method may be to calculate min_net_buffer and max_net_buffer using one or more specifications of the wireless network. The above methods are listed for illustrative purposes only and the method, or methods, used to set min_net_buffer and max_net_buffer are not critical and different methods may yield different results.

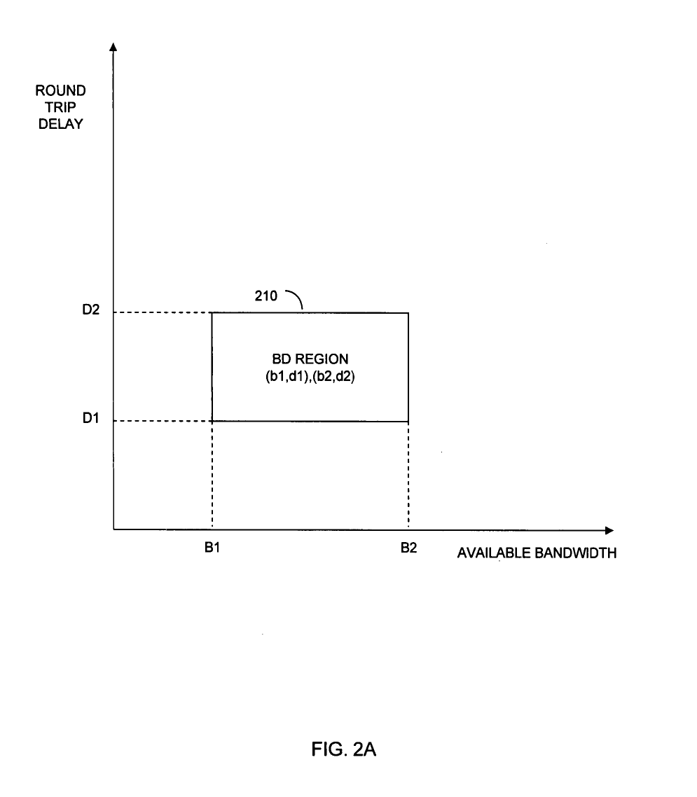

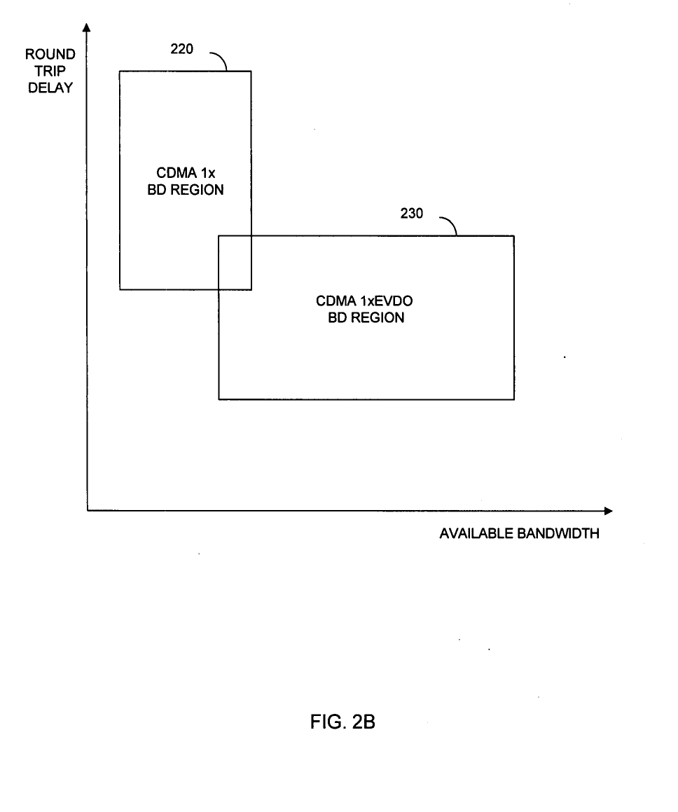

One illustration of how a wireless network type may be differentiated by its network characteristics is through the use of a bandwidth-delay (BD) region. A BD region is a representation of the typical bandwidths and propagation delays of a wireless network type. FIG. 2A is one embodiment of a graphical representation of a BD region 210 for a wireless network type. In the embodiment of FIG. 2, BD region 210 is the area bounded by B1, B2, D1, and D2.

FIG. 2B is one embodiment of a graphical representation of the relative positions of BD region 220 of a CDMA2000 1× network and the BD region 230 of a CDMA2000 1×EVDO network. It should be appreciated that the positions of BD region 220 and BD region 230 are relative and no quantitative data should be derived from FIG. 2B.

In one embodiment, a TCP module in a sender 110 or a receiver 140 may be adapted to optimize a TCP session for a wireless network 130 by determining the network characteristics of wireless network 130. The network characteristics may be determined by comparing the estimated bandwidth and estimated delay to one or more pre-stored sets of network characteristics. In another embodiment, the network characteristics may be determined by an initial network type, which may point to a pre-stored set of network characteristics.

By determining the estimated bandwidth and estimated propagation delay of a wireless network 130 during a TCP session and comparing these values to the values of B1, B2, D1, and D2 for one or more network types, the BD region and thus the corresponding network characteristics of the wireless network 130 may be determined. For example, in the embodiment shown in FIG. 2B, if the estimated bandwidth and estimated propagation delay fall within BD region 220, it may be determined that the network characteristics for a CDMA2000 1× network should be selected. If, on the other hand, the estimated bandwidth and estimated propagation delay fall within BD region 230, it may be determined that network characteristics for a CDMA2000 1×EVDO network should be selected.

It is possible that the network characteristics for one wireless network type may be selected when the wireless network 130 is another wireless network type. This may occur for a variety of reasons. For example, a receiver 140 or sender 110 in communication with a CDMA2000 1×EVDO network may experience CDMA2000 1× like service due to poor environmental conditions, frequent base transceiver station (BTS) handoffs, or high traffic loads. In addition, sender 110 or receiver 140 may experience CDMA2000 1× like service if receiver 140 is a CDMA2000 1× only capable device. In situations such as these, it may be proper to select the network characteristics associated with a CDMA2000 1× network.

It should be appreciated that the above examples are for exemplary purposes only and other wireless network types, such as UTRAN, GPRS, EDGE, etc may be differentiated by their network characteristics.

A TCP module in a sender 110 or a receiver 140 may be further adapted to update one or more TCP session parameters based at least in part on the determined network characteristics. In one embodiment, the TCP session parameters may be updated with values determined after the network characteristics are determined, wherein the values are based at least in part on the network characteristics. In another embodiment, the TCP session parameters may be updated with corresponding pre-stored session parameters associated with the network characteristics, wherein the pre-stored session parameters were pre-determined based at least in part on the associated network characteristics. A sender 110 or receiver 140 may contain one or more sets of pre-stored session parameters. The TCP session parameters may include a minimum congestion window (min_CWND), a maximum congestion window (max_CWND), a maximum retransmission timeout (max_RTO), a low queuing delay threshold (low_QD), a high queuing delay threshold (high_QD), a congestion avoidance coefficient (speed_UP), a congestion window decrease coefficient (speed_DOWN), and a lossy network flag (ln_FLAG).

In one embodiment, a TCP module in a sender 110 or a receiver 140 may not be adapted to determine the network characteristics of wireless network 130, but instead be programmed with a set of network characteristics usable to update the TCP session parameters. In this embodiment, it is not necessary to determine the network characteristics. In another embodiment, a TCP module in a sender 110 or a receiver 140 may not be programmed with a set of network characteristics, but instead be programmed with pre-determined TCP session parameters based at least in part on the network characteristics of a wireless network type. In this embodiment, it is not necessary to determine the network characteristics or update the TCP session parameters.

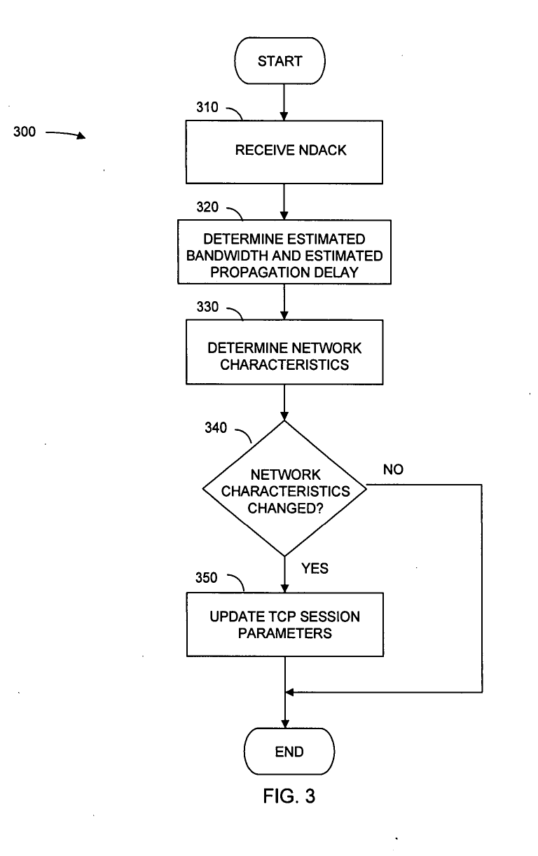

FIG. 3 displays one embodiment of a process 300 to update one or more TCP session parameters in a network node in communication with a wireless network (e.g. wireless network 130) during the TCP session. The network node may be a sender (e.g. sender 110) or a receiver (e.g. receiver 140).

Update process 300 begins at block 310 when a non-duplicate acknowledgment (NDACK) is received by the network node in response to a segment that was previously transmitted. An NDACK is an acknowledgment (ACK) that has been transmitted by a TCP module in a receiver in response to the receipt of an in-order segment from a sender. A duplicate ACK (DACK), on the other hand, is an ACK sent by a TCP module in a receiver in response to the receipt of an out-of-order segment. For example, if a receiver receives segment 1 before receiving any other segment, it will send out an NDACK for segment 1. If a receiver then receives segment 3 before receiving segment 2, it will send out a DACK. It should be appreciated that an NDACK received by the sender in block 1 may also be a delayed ACK as the term is known in the art.

Although block 310 shows that process 300 starts upon the receipt of an NDACK, it should be appreciated that the receipt of more than one NDACK may be required. In addition, in certain embodiments, spuriously large NDACKs due to conditions such as Automatic Repeat reQuest (ARQ) protocol retransmissions or BTS handoffs may be discarded.

Process 300 proceeds to block 320 where the estimated bandwidth and the estimated propagation delay of the wireless network are determined. In certain embodiment, the estimated bandwidth may be determined by observing the arrival rates of NDACKs, sending special probe packet trains, or any other suitable method. It should be appreciated the method used to determine the estimated bandwidth may not determine the actual or theoretical bandwidth of the wireless network.

The estimated propagation delay may be determined by tracking the minimum Round Trip Time (RTT) observed during a TCP session. An RTT is the elapsed time between the transmission of a data segment and the receipt of a corresponding NDACK. It may be expressed in units of time, clock cycles or any other suitable timing parameter. In one embodiment, the minimum observed RTT may be the estimated propagation delay. It should be appreciated that the method used to determine the estimated propagation delay may not yield the actual or theoretical propagation delay. It should be further appreciated that other methods to determine the estimated propagation delay may be used.

In one embodiment, the estimated bandwidth and estimated propagation delay of the wireless network may be determined in a TCP module in the network node. In another embodiment, the estimated bandwidth and/or estimated propagation delay may be determined in one or more separate estimation modules running outside of the TCP module in the network node. Global kernel variables and/or software interrupts may be used to do the inter-process communication (IPC) between the one or more estimation modules and the TCP module.

Regardless of how the estimated bandwidth and the estimated propagation delay are determined, once they are determined process 300 may proceed to block 330 where the network characteristics of the wireless network may then be determined. In certain embodiment, the network characteristics may be determined by comparing the estimated bandwidth and the estimated propagation delay determined in block 320 to one or more sets of pre-stored network characteristics in the network node. A pre-stored set of network characteristics may include the values of B1, B2, D1, D2, min_net_buffer, and max_net_buffer associated with a network type.

It should be appreciated that the above process may not determine the actual network characteristics of the wireless network. Rather, it may determine the perceived network characteristics of a wireless network. For example, a wireless network that is a CDMA2000 1×EVDO network may at times behave as a CDMA2000 1× network because of poor environmental conditions or high traffic loads, or because the receiver is a CDMA2000 1× mobile device. Therefore, the network characteristics may be determined to be those of a CDMA2000 1× network, when in fact the underlying wireless network is a CDMA2000 1×EVDO network. In situations such as these, it is proper to select the network characteristics associated with a CDMA2000 1× network. Although CDMA2000 1× and CDMA2000 1×EVDO networks have been used in the previous example, it should be appreciated that other wireless networks are equally applicable.

In certain embodiments, the network characteristics may be loaded into one or more variables. In one embodiment, a pointer may be set to a pre-stored set of network characteristics. In another embodiment, a network type variable may be set, based on the determined network characteristics.

Still referring to FIG. 3, after the network characteristics are determined, process 300 proceeds to block 340 where a determination of whether the network characteristics have changed is made (i.e. whether the network characteristics determined in block 330 are different than the last determined network characteristics, if any). If the network characteristics have changed, process 300 proceeds to block 350 where one or more of the TCP session parameters may be updated. Otherwise the process ends. It should be appreciated that in certain embodiments, block 340 may be omitted and process 300 may update one or more TCP session parameters after every determination of the network characteristics.

At block 350, one or more TCP session parameters are updated. In certain embodiments, one or more TCP session parameters may be updated with values based at least in part on the determined network characteristics, wherein the values are determined after the network characteristics are determined. In another embodiment, the TCP session parameters may be updated with a pre-stored set of session parameters based at least in part on the determined network characteristics. A network node may contain one or more pre-stored sets of session parameters.

While in certain embodiments, the TCP session parameters are updated by loading a pre-stored set of session parameters or by determining values based on the network characteristics, it should be appreciated that the TCP session parameters may be updated by having a pointer point to a pre-stored set of session parameters.

In one embodiment, one or more pre-stored session parameters or pre-stored network characteristics may be adjustable by the user of a network node that contains a TCP module consistent with the principles of the invention. In another embodiment, one or more pre-stored session parameters or pre-stored network characteristics may be adjustable by another party. For example, one or more pre-stored session parameters or pre-stored network characteristics on a cellular phone may be adjustable over the cellular network by the operator of the cellular network or a software vendor.

The TCP session parameters updated in block 350 may include one or more of min_CWND, max_CWND, max_RTO, low QD, high_QD, speed_UP, speed_DOWN, and ln_FLAG. The parameter min_CWND may be based at least in part on the product of B1 multiplied by D1. In one embodiment, min_CWND may be determined according to the relation: min_CWND=B1*D1+min_net_buffer. It should be appreciated that the above relation is for illustrative purposes only and other relations that factor in a product of B1 multiplied by D1 are equally valid. For example, B1*D1 may be multiplied by a coefficient and/or min_net_buffer may be omitted or replaced with a constant.

The parameter max_CWND may be based at least in part on the product of B2 multiplied by D2. In one embodiment, max_CWND may be determined according to the relation: max_CWND=B2*D2+max_net_buffer. It should be appreciated that the above relation is for illustrative purposes only and other relations that factor in a product of B2 multiplied by D2 are equally valid. For example, B2*D2 may be multiplied by a coefficient and/or max_net_buffer may be omitted or replaced with a constant.

The parameter high_QD may be based at least in part on the product of max_net_buffer divided by B2. In one embodiment, high_QD may be determined according to the relation: high_QD=max_net_buffer/B2. It should be appreciated that the above relation is for illustrative purposes only and other relations that factor in a product of max_net_buffer divided by B2 are equally valid. For example, max_net_buffer/B2 may be multiplied by a coefficient and/or a constant may be added.

The parameter low_QD may be based at least in part on the product of min_net_buffer divided by B2. In one embodiment, low_QD may be determined according to the relation: low_QD =min_net_buffer/B2. It should be appreciated that the above relation is for illustrative purposes only and other relations that factor in a product of min_net_buffer divided by B2 are equally valid. For example, max_net_buffer/B2 may be multiplied by a coefficient and/or a constant may be added.

The parameter max_RTO may be based at least in part on a multiple of the sum of D2 and high_QD. In one embodiment, max_RTO may be determined according to the relation max_RTO=2*(D2+high_QD). It should be appreciated that the above relation is for illustrative purposes only and other relations that factor in D2 and high_QD are equally valid. For example, 2 may be replaced with another coefficient and/or a constant may be added.

The parameter speed_UP may be based on a corresponding network characteristic, which may be a constant (e.g. 1, 2, 3), or it may be based at least in part on one or more other network characteristics.

The parameter speed_DOWN may be based on a corresponding network characteristic, which may be a constant (e.g. 1, 2, 3), or it may be based at least in part on one or more other network characteristics.

The parameter ln_FLAG may be based on a corresponding network characteristic or it may be based on one or more other network characteristics.

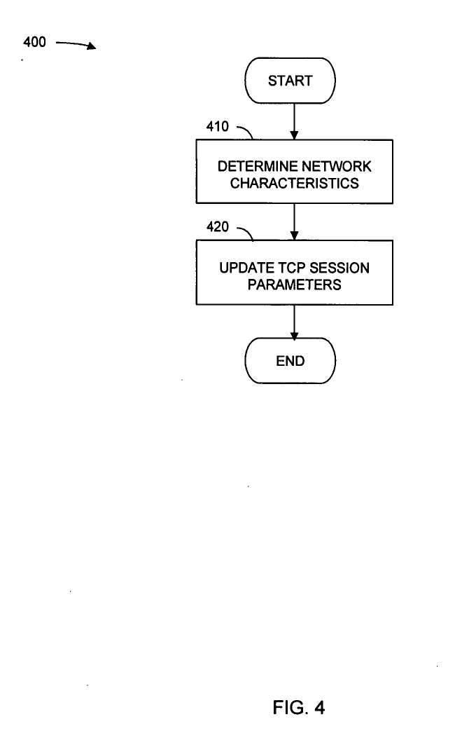

FIG. 4 displays one embodiment of a process 400 to update one or more TCP session parameters before the start of a TCP session or at the start of a TCP session. One or both blocks of process 400 may occur outside of the network node.

Process 400 begins at block 410 when the network characteristics are determined. In one embodiment, the network characteristics may be determined outside of the network node and programmed into the network node. When the TCP session starts, these network characteristics may be used to update the TCP session parameters with values based at least in part on the network characteristics or with pre-stored session parameters associated with the network characteristics. In another embodiment, the network characteristics may be determined by determining the estimated bandwidth and estimated propagation delay at the start of the TCP session and comparing them to stored network characteristics.

In another embodiment, the network characteristics may be determined outside of the network node and not programmed into the network node. Instead, the TCP session parameters may be updated with values based at least in part on the network characteristics, and then programmed into the network node. In such an embodiment, it would not be necessary to determine the network characteristics or update the TCP session parameters at the start of the TCP session.

Process 400 proceeds to block 420 where the TCP session parameters are updated. As mentioned above, the TCP session parameters in one embodiment may be updated outside of the network node with values based at least in part on the network characteristics determined outside of the network node. In another embodiment, the TCP session parameters may be updated inside the network node with values based at least in part on the network characteristics or with pre-stored session parameters associated with the network characteristics.

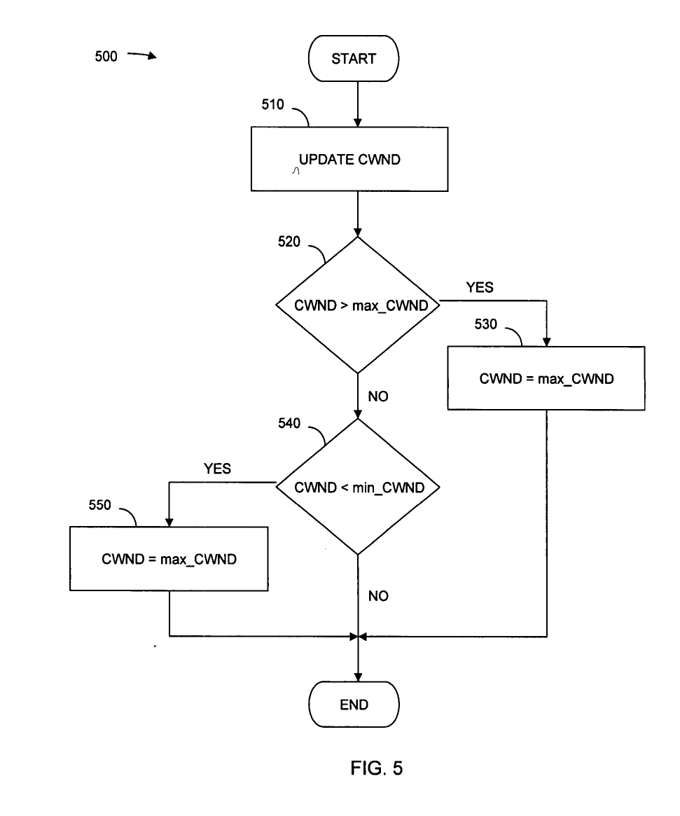

FIG. 5 displays one embodiment of how min_CWND and max_CWND may be used to limit CWND during a TCP session in a network node. Process 500 begins with the update of CWND, as shown in block 510. CWND may be updated via several methods during a TCP session. For example, in the slow start phase outlined in RFC 2583, CWND is increased by 1 for each NDACK received. In the congestion avoidance phase outlined in RFC 2583, CWND is increased by 1 for every CWND number of segments acknowledged by one or more NDACKs. These examples should not be read as a limitation on the invention, as it is applicable to any update of CWND.

Process 500 proceeds to block 520 where CWND is compared to max_CWND. If CWND is greater than max_CWND, then process 500 proceeds to block 530 where CWND is set to max_CWND. If, however, CWND is less than or equal to max_CWND, then process 500 proceeds to block 540.

At block 540, CWND is compared to min_CWND. If CWND is less than min_CWND, then process 500 proceeds to block 550 where CWND is set to min_CWND. If, however, CWND is greater than min_CWND, then it remains unchanged.

An example of where CWND may be limited is the update of CWND that occurs after a TCP retransmission timer indicates that a packet has been lost (i.e. a timeout). In some TCP implementations, CWND is reduced to a small value after a timeout, usually between 1 and 4. However, instead of CWND being reduced to a value between 1 and 4, it may be reduced to the value of min_CWND.

Another example of where CWND may be limited is the update of CWND that may occur in the congestion avoidance phase. In some TCP implementations, CWND is updated by 1 for every CWND number of segments (or bytes if CWND is not expressed in segments) acknowledged. If CWND exceeds max_CWND in the congestion avoidance phase, then it may be set to max_CWND.

The order of one or more of the acts depicted in process 500 may be changed while still conforming to the principles of the invention. For example, in certain embodiments, CWND may be compared to min_CWND before being compared to max_CWND. Depending on the TCP process used to update CWND, it may be necessary to only compare CWND to max_CWND and not min_CWND (e.g. when CWND is increased), and vice-versa (e.g. when CWND is decreased). In addition, CWND may be limited by the size of the receive window (RWND) of a receiver.

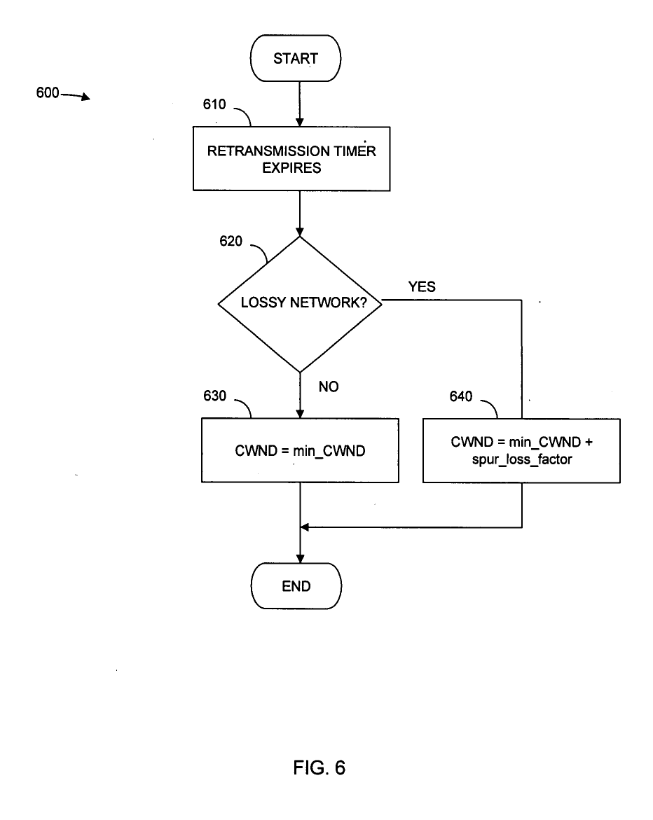

FIG. 6 depicts one embodiment of how CWND may be determined after a timeout occurs due to a spurious data segment loss. Process 600 starts at block 610 when a timeout occurs and a data segment is presumed lost. Process 600 may then proceed to block 620 where a determination of whether the segment loss was spurious is made. Spurious segment loss may be defined as any segment loss that is not congestion related, such as segment loss due to packet corruption or bit errors. In a wireless network, segment loss is more likely to be spurious than congestion related, whereas in a wired network, the opposite is more likely to be true. Furthermore, some wireless networks are more susceptible to spurious segment loss than others and may be considered to be lossy networks.

In one embodiment, a determination of whether the segment loss was spurious may be made by looking at ln_FLAG. If ln_FLAG indicates that the wireless network type is a lossy network, then the segment loss may be presumed to be spurious. In another embodiment, a determination of whether the segment loss was spurious may be made based on the relative proportion of timeouts to NDACKs. It should be appreciated that other factors such as the size of CWND, the size of RWND, and one or more RTTs may be used to determine whether a segment loss was spurious.

If the segment loss was non-spurious, then process 600 proceeds to block 630 where CWND is set to min_CWND. If, however, the segment loss was spurious, then process 600 proceeds to block 640 where CWND is set to min_CWND plus an spurious loss factor (spur_loss_FACTOR). In one embodiment, the spur_loss_FACTOR may be a fraction of the difference of max_CWND and min_CWND. In one embodiment, spur_loss_FACTOR may be determined according to the relation: spur_loss_FACTOR=b*(max_CWND−min_CWND)/(B1+B2), where b is the estimated bandwidth as determined in process 300.

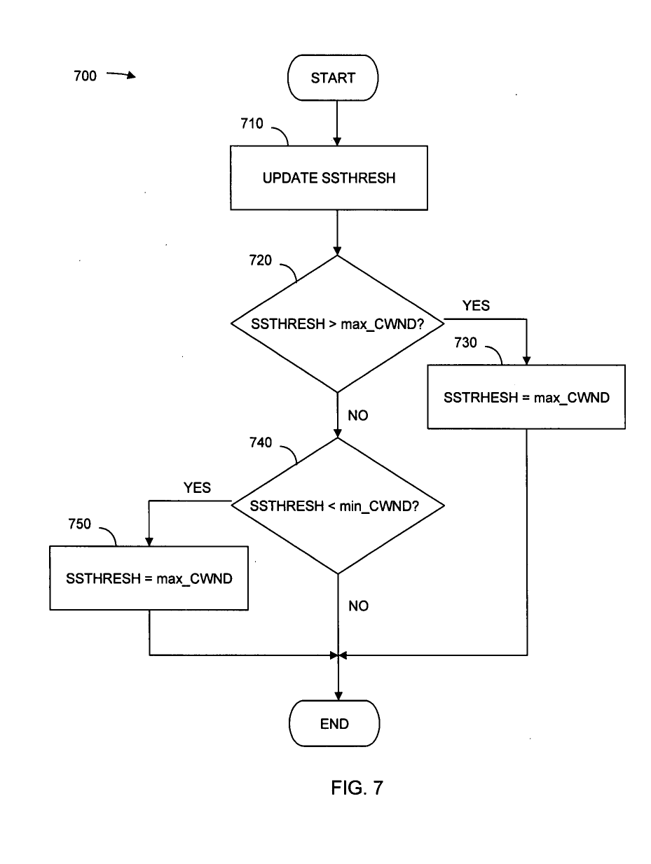

FIG. 7 displays one embodiment of how min_CWND and max_CWND may be used to limit the slow start threshold (SSTHRESH) during a TCP session in a network node.

Process 700 begins upon the update of SSTHRESH, as shown in block 710. SSTHRESH may be updated via several methods during a TCP session. For example, at startup some TCP implementations set SSTHRESH to the size of the RWND. In another example, SSTHRESH may be reduced to a percentage of CWND in the TCP fast recovery phase. These examples should not be read as a limitation on the invention, as it is applicable to any update of SSTHRESH.

Process 700 proceeds to block 720 where SSTHRESH is compared to max_CWND. If SSTHRESH is greater than max_CWND, then process 700 proceeds to block 730 where SSTHRESH is set to max_CWND. If, however, SSTHRESH is less than max_CWND, then process 700 proceeds to block 740.

At block 740, SSTHRESH is compared to min_CWND. If SSTHRESH is less than min_CWND, then process 700 proceeds to block 750 where SSTHRESH is set to min_CWND. If, however, SSTHRESH is greater than min_CWND then it remains unchanged.

An example of where SSTHRESH may be limited is the update of SSTHRESH that occurs after a timeout. In some TCP implementations, SSTHRESH is reduced to one half the value of CWND after a timeout. However, if as the result of this reduction, SSTHRESH is less than min_CWND, then SSTHRESH may be set to min_CWND.

Another example of where SSTHRESH may be limited is at the start of the TCP session. In some TCP implementations, SSTHRESH is set to an arbitrary high value or to RWND. If, however, this arbitrary high value or RWND is higher than max_CWND, then SSTHRESH may be set to max_CWND.

The order of one or more of the acts depicted in process 700 may be changed while still conforming to the principles of the invention. For example, in certain embodiments, SSTHRESH may be compared to min_CWND before being compared to max_CWND. Depending on the TCP process used to update SSTHRESH, it may be necessary to only compare SSTHRESH to max_CWND and not min_CWND (e.g. when SSTHRESH is increased), and vice-versa (e.g. when SSTHRESH is decreased). In addition, SSTHRESH may be limited by RWND.

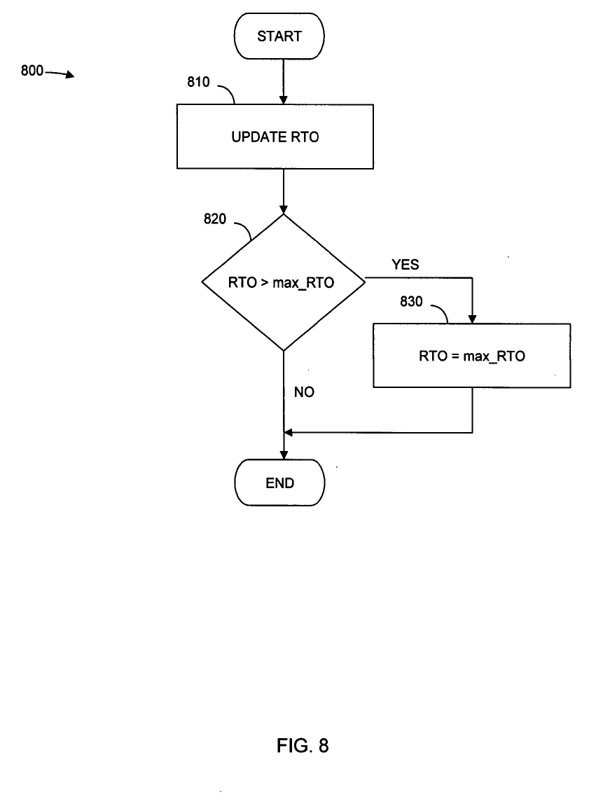

FIG. 8 displays one embodiment of how a retransmission timeout may be limited to less than or equal to max_RTO during a TCP session in a network node. Process 800 starts at block 810 when RTO for the next segment to be transmitted (or retransmitted) is determined. RTO may be determined via several methods in a TCP session. For example, RTO may be determined by one method upon the receipt of an NDACK and by another method when a retransmission timer expires.

Process 800 proceeds to block 820 where RTO is compared to max_RTO. If RTO is greater than max_RTO, then process 800 proceeds to block 830 where RTO is set to max_RTO. If, however, RTO is less than max_RTO, it remains unchanged.

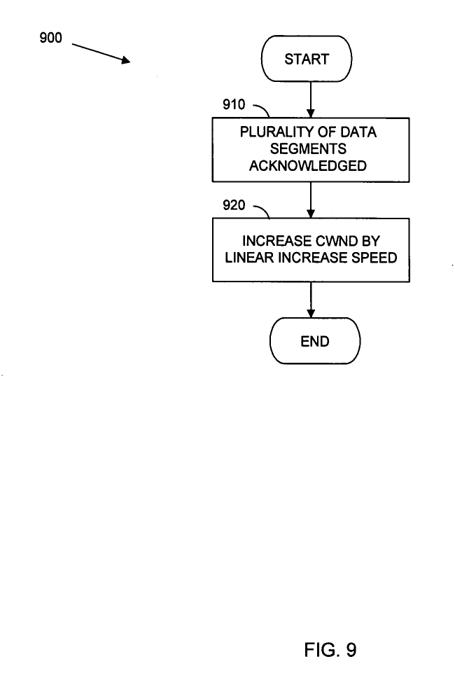

Referring now to FIG. 9, depicted is one embodiment of how speed_UP may be used to increase CWND during the TCP congestion avoidance phase. The congestion avoidance phase is used in a TCP session after CWND reaches or exceeds the value of SSTHRESH in the slow start phase, or after congestion is detected by the receipt of a series of duplicate acknowledgments (DACKs). In certain TCP implementations, CWND is updated by 1 during the congestion avoidance phase for every CWND number of segments acknowledged by a receiver in the form of NDACKs. It should be noted that some TCP implementations do not express CWND as a number of segments, but as a number of bytes. This process is applicable to those implementations as well, however for the sake of simplicity CWND has been expressed here as a number of segments.

Process 900 begins when a plurality of data segments have been acknowledged in block 910. Process 900 proceeds to block 920 where CWND is increased by speed_UP. This differs from the usual implementations of TCP in that speed_UP is not limited to 1 and the plurality of data segments acknowledged in block 910 is not limited to CWND number of segments. It should be appreciated that CWND is still limited to no more than max_CWND.

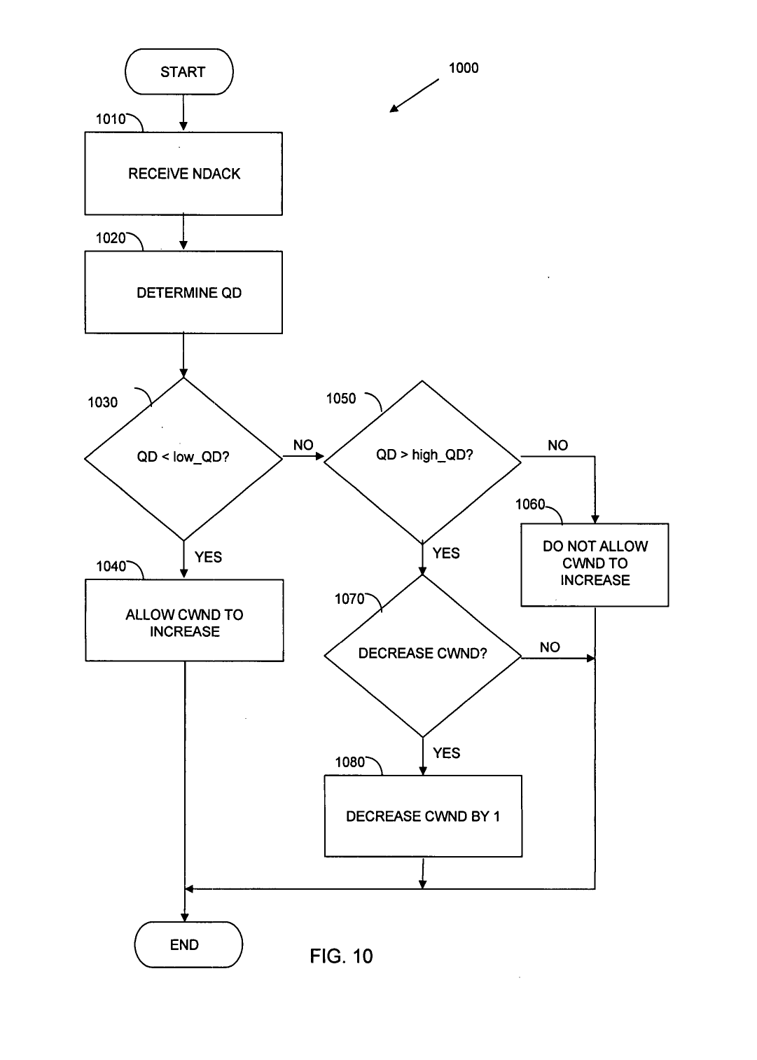

FIG. 10 depicts one embodiment of how high_QD and low_QD may be used to override the CWND update processes in a TCP module. Process 1000 begins at block 1010 when an NDACK is received. In certain embodiments, the receipt of a plurality of NDACKs may be required. Process 1000 then proceeds to block 1020 where the current queuing delay (QD) of the wireless network is estimated.

In certain embodiments, the current QD is the portion of the RTT of a data segment that is not due to the propagation delay. For example, the current QD may be determined to be the RTT minus the estimated propagation delay. It should be appreciated that the current QD may also be determined to be an average of a plurality of RTTs minus the estimated propagation delay.

Regardless of how the current QD is determined, process 1000 proceeds to block 1030 where the current QD is compared to low_QD. If the current QD is less than low_QD, process 1000 proceeds to block 1040 where CWND is allowed to increase using any applicable standard TCP CWND increase process (e.g. slow start, congestion avoidance) or a modified CWND increase process (e.g. modified congestion avoidance process 900). It should be appreciated that although CWND is allowed to increase in block 1040, it does not necessarily have to increase as that is determined by the applicable CWND increase process.

If the current QD is not less than low_QD, process 1000 proceeds to block 1050 where the current QD is compared to high_QD. If the current_QD is less than high_QD, then process 1000 proceeds to block 1060 where CWND is prohibited from increasing using any standard or modified CWND increase process.

If the current QD is greater than high_QD, then process 1000 proceeds to block 1060 where it is determined whether CWND should be decreased. In one embodiment, CWND is decreased if a plurality of NDACKs are received after the current QD becomes greater than high_QD and while the current QD remains greater than high_QD. CWND may also be decreased if a plurality of NDACKs are received after the last such decrease and the current QD remains greater than high_QD.

In one embodiment, the number of NDACKs required to decrease CWND may be equal to the value of CWND divided by the session parameter speed_DOWN. In another embodiment, the number of NDACKs required to decrease CWND may be a constant number, such as 1,2,3, etc.

If a determination to not decrease CWND is made in block 1070, then process 1000 ends. Otherwise, process 1000 proceeds to block 1080 where CWND is decreased by 1. It should be appreciated that in other embodiments, CWND may be decreased by more than 1 in block 1080.

While the processes of FIGS. 3-10 have been described in the above embodiments, it should be appreciated that these are for exemplary value only and other embodiments are applicable to the current invention. The order of one or more of the acts depicted in the processes of FIGS. 3-10 may be changed while still conforming to the principles of the invention. For the sake of simplicity, the processes of FIGS. 3-10 have has been defined in general steps and it should be appreciated that other steps consistent with the principles of the invention may be included.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for optimizing a Transmission Control Protocol (TCP) session for a sender in communication with a wireless network comprising the acts of:
determining a plurality of network characteristics of the wireless network; and
updating one or more TCP session parameters based on said plurality of network characteristics.

2. The method of claim 1, wherein determining said plurality of network characteristics comprises selecting a plurality of pre-stored initial network characteristics.

3. The method of claim 1, wherein determining said plurality of network characteristics comprises the acts of:
determining an estimated bandwidth and an estimated propagation delay of the wireless network;
comparing the estimated bandwidth and the estimated propagation delay of the wireless network to one or more sets of pre-stored network characteristics; and
selecting a set of pre-stored network characteristics based on a result of said comparing.

4. The method of claim 3 wherein comparing the estimated bandwidth and the estimated delay to the one or more sets of pre-stored network characteristics comprises the acts of:
comparing the estimated bandwidth to one or more minimum bandwidths and one or more maximum bandwidths, wherein said one or more minimum bandwidths and said one or more maximum bandwidths are contained in the one or more sets of pre-stored network characteristics; and
comparing the estimated propagation delay to one or more minimum propagation delays and one or more maximum propagation delays, wherein said one or more minimum propagation delays and said one or more maximum propagation delays are contained in the one or more sets of pre-stored network characteristics.

5. The method of claim 1, wherein updating the one or more session parameters comprises the act of updating the one or more TCP session parameters with one or more corresponding pre-stored session parameters, wherein said one or more corresponding pre-stored session parameters are based at least in part on the plurality of network characteristics.

6. The method of claim 1, wherein updating the one or more TCP session parameters comprises the act of updating the one or more session parameters with one or more corresponding values, wherein said values are based at least in part on said plurality of network characteristics

7. The method of claim 1, wherein said plurality of network characteristics include one or more of a minimum bandwidth, a maximum bandwidth, a minimum propagation delay, a maximum propagation delay, a minimum network buffer capacity, and a maximum network buffer capacity and wherein said one or more session characteristics include one or more of a minimum congestion window, a maximum congestion window, a maximum retransmission timeout, a low queuing delay threshold, a high queuing delay threshold, and a lossy network flag.

8. The method of claim 7, wherein the minimum congestion window is based at least in part on the minimum network bandwidth multiplied by the minimum network delay and wherein the maximum congestion window is based at least in part on the maximum network bandwidth multiplied by the maximum network delay.

9. The method of claim 8, further comprising the act of limiting a congestion window and a slow start threshold to a range defined by the minimum congestion window and the maximum congestion window.

10. The method of claim 8, further comprising, upon an expiration of a retransmission timer, the act of determining a congestion window based at least in part on the minimum congestion window subtracted from the maximum congestion window, the difference being then multiplied by a current estimated bandwidth of the wireless network, the product of which is then divided by the difference of the maximum bandwidth and the minimum bandwidth.

11. The method of claim 1, further comprising the act of increasing a congestion window by a congestion avoidance coefficient upon a receipt of a plurality of non-duplicate acknowledgments during a TCP congestion avoidance phase.

12. The method of claim 7, wherein the low queuing delay is based at least in part on the minimum network buffer capacity divided by the maximum bandwidth and wherein the high queuing delay is based at least in part on the maximum network buffer capacity divided by the maximum bandwidth.

13. The method of claim 12, further comprising the acts of:
determining a current queuing delay of the wireless network, wherein the current queuing delay is based at least in part on an estimated propagation delay of the wireless network subtracted from one of a round trip time of a data segment and an average of a plurality of round trip times of a plurality of data segments; and
taking at least one other action wherein said one other action is selected from a group consisting of:
allowing an increase of a congestion window when the current queuing delay is less than the low queuing delay threshold;
prohibiting an increase of the congestion window when the current queuing delay is within a range defined by the low queuing delay threshold and the high queuing delay threshold; and
decreasing, upon the receipt of a plurality of non-duplicate acknowledgments, the congestion window when the current queuing delay is greater than the high queuing delay threshold.

14. A method for optimizing a Transmission Control Protocol (TCP) session for a sender in communication with a wireless network comprising the acts of:
determining an estimated bandwidth of the wireless network and an estimated propagation delay of the wireless network;
comparing the estimated bandwidth of the wireless network and the estimated propagation delay of the wireless network to one or more sets of pre-stored network characteristics;
selecting a set of pre-stored network characteristics based on a result of said comparing; and
updating one or more TCP session parameters based on said plurality of network characteristics.

15. A network node comprising:
a network interface adapted to provide connectivity to a data network;
a processor coupled to said network interface; and
a memory coupled to said processor, said memory containing processor executable instruction sequences to cause the processor to:
determine a plurality of network characteristics of a wireless network; and
update one or more TCP session parameters based on said plurality of network characteristics.

16. The network node of claim 15, wherein said processor executable instruction sequences to cause the processor to determine a plurality of network characteristics comprise processor executable instruction sequences to cause the processor to read a plurality of stored network characteristics.

17. The network node of claim 15, wherein said processor executable instruction sequences to cause the processor to determine a plurality of network characteristics comprise processor executable instruction sequences to cause the processor to:
determine an estimated bandwidth of the wireless network and an estimated propagation delay of the wireless network;
compare the estimated bandwidth and the estimated propagation delay to one or more sets of pre-stored network characteristics; and
select a set of pre-stored network characteristics based on a result of said comparison.

18. The network node of claim 17, wherein said processor executable instruction sequences to cause the processor to compare the estimated bandwidth and the estimated propagation delay to one or more sets of pre-stored network characteristics comprise processor executable instruction sequences to cause the processor to:
compare the estimated bandwidth to one or more minimum bandwidths and one or more maximum bandwidths, wherein said one or more minimum bandwidths and said one maximum bandwidths are contained in the one or more sets of pre-stored network characteristics; and
compare the estimated propagation delay to one or more minimum propagation delays and one or more maximum propagation delays, wherein said one or more minimum propagation delays and said one or more maximum propagation delays are contained in the one or more sets of pre-stored network characteristics.

19. The network node of claim 15, wherein said processor executable instruction sequences to cause the processor to update the one or more TCP session parameters comprise processor executable instruction sequences to cause the processor to update the one or more TCP session parameters with one or more corresponding pre-stored session parameters that are based at least in part on the plurality of network characteristics.

20. The network node of claim 15, wherein said processor executable instruction sequences to cause the processor to update the one or more TCP session parameters comprise processor executable instruction sequences to cause the processor to update the one or more TCP session parameters with one or more corresponding values that are based at least in part on said plurality of network characteristics.

21. The network node of claim 15, wherein said plurality of network characteristics include one or more of a minimum bandwidth, a maximum bandwidth, a minimum propagation delay, a maximum propagation delay, a minimum network buffer capacity, and a maximum network buffer capacity and wherein said one or more session characteristics include one or more of a minimum congestion window, a maximum congestion window, a maximum retransmission timeout, a low queuing delay threshold, a high queuing delay threshold, and a lossy network flag.

22. The network node of claim 21, wherein the minimum congestion window is based at least in part on the minimum network bandwidth multiplied by the minimum network delay and wherein the maximum congestion window is based at least in part on the maximum network bandwidth multiplied by the maximum network delay.

23. The network node of claim 22, wherein said memory further contains processor executable instruction sequences to cause the processor to limit a congestion window and a slow start threshold to a range defined by the minimum congestion window and the maximum congestion window.

24. The network node of claim 22, wherein said memory further contains processor executable instruction sequences to cause the processor to, upon an expiration of a retransmission timer, determine a congestion window based in at least in part on the minimum congestion window subtracted from the maximum congestion window, the difference being then multiplied by an estimated bandwidth of the wireless network, the product of which is then divided by the difference of the maximum bandwidth and the minimum bandwidth.

25. The method of claim 15, wherein said memory further contains processor executable instruction sequences to increase a congestion window by a congestion avoidance coefficient upon a receipt of a plurality of non-duplicate acknowledgments during a TCP congestion avoidance phase.

26. The method of claim 21, wherein the low queuing delay is based at least in part on the minimum network buffer capacity divided by the maximum bandwidth and wherein the high queuing delay is based at least in part on the maximum network buffer capacity divided by the maximum bandwidth.

27. The method of claim 26, wherein said memory further contains processor executable instruction sequences to cause the processor to:
determine a current queuing delay of the wireless network, wherein the current queuing delay is based at least in part on an estimated propagation delay of the wireless network subtracted from either a round trip time of a data segment of an average of a plurality of round trip times of a plurality of data segments; and
take at least one other action, wherein said one other action is selected from a group consisting of:
allow an increase of a congestion window when the current queuing delay is less than the low queuing delay threshold;
prohibit an increase of the congestion window when the current queuing delay is within a range defined by the low queuing delay threshold and the high queuing delay threshold; and
decrease, upon the receipt of a plurality of non-duplicate acknowledgments, the congestion window when the current queuing delay is greater than the high queuing delay threshold.
